(19) United States
(12) Patent Application Publication
(10) Pub. No.: US 2006/0115189 A1
(43) Pub. Date: Jun. 1, 2006

(54) Roller bearing having at least one rotatable roller

(75) Inventor: Hermann Koch, Gerhardshofen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/184,068

(22) Filed: Jul. 19, 2005

(30) Foreign Application Priority Data
Jul. 20, 2004 (DE) 10 2004 035 909.1

(51) Int. Cl. F16C 19/00

(52) U.S. Cl. 384/50

(57) ABSTRACT

A roller bearing having at least one rotatable roller is used to move an elongated body. The elongated body rests on the rotatable roller and can be moved transversely with respect to the axis of rotation of the roller. In order to prevent the body (4) becoming jammed on the roller, the rotatable roller can be pivoted about an axis which is oriented approximately parallel to the direction of movement of the body.

### CLAIM FOR PRIORITY

This application claims the benefit of priority to German Application No. 10309200.5 which was filed in the German language on Jan. 21, 2004, the contents of which are hereby incorporated by reference.

### TECHNICAL FIELD OF THE INVENTION

The invention relates to a roller bearing having at least one rotatable roller, and in particular, having a rotatable roller on which an elongated body to be moved can be placed, the axis of rotation of the roller being arranged transversely with respect to the direction of movement of the body.

### BACKGROUND OF THE INVENTION

Such roller bearings are used, for example, in laying energy transmission devices such as cables or gas-insulated pipelines. The route of which the device is laid often has turns, bends, depressions and hills. As a result of the twists and turns the elongated body is turned on itself along its axis of rotation. As a result of this rotation, further forces act on the roller bearing in addition to the tensile forces. Owing to the twisted, non-linear routes over which the devices are laid it is necessary that the elongated body to be moved be guided carefully in order to avoid locking of the rotatable rollers or jamming of the body in the roller bearings.

### SUMMARY OF THE INVENTION

The invention specifies a roller bearing which permits locking-free movement of the elongated body. This allows the rotatable roller to be pivoted about an axis.

As a result of pivotable bearing of the rotatable roller it is possible for the supporting direction of the roller to be set according to requirements. As a result, for example when laying a pressurized-gas-insulated electrical conductor it is possible for the rollers to be pivoted over a hill or in a depression in a way that corresponds to the profile of the route. This permits the body to be transported to be deflected in a more gentle way.

In this context it is advantageously possible to provide for the axis to be located approximately parallel to the direction of movement of the body.

In particular, when the body to be transported is twisted owing to the route over which the device is laid, lateral pivoting of the rotatable roller is advantageous in order to be able to better absorb transverse sources which occur. It is thus possible, for example in the region of tight bends, for a greater degree of support to be provided for the body to be moved on the side facing the inside of the bend and for the roller to pivot into this region. In this context, the pivot axis of the roller is to be selected in such a way that it lies approximately parallel to the direction of movement of the body. In a bend region the tangent about which the roller is arranged so as to pivot around is to be adopted. Since the roller is also loaded more evenly on bend profiles or in depressions or on hills, jamming of the roller is virtually ruled out.

In a further advantageous embodiment of the invention, the at least one roller is mounted on a pivot bearing which has a fixed element and a loose element, wherein at least one of the elements has a curved sliding face which is mounted in a sliding fashion on the respective other element.

The use of a sliding face ensures virtually step-free setting of the pivoting movement of the rotatable roller. Furthermore, a slight degree of sliding is made possible when the sliding face correspondingly expands. There may be provision here for the sliding face to be, for example, curved in such a way that, in addition to the pivoting movement of the rotatable roller about an axis parallel to the direction of movement of the body, a rotational movement of the roller about a perpendicular component and/or pivoting in the direction of transport of the roller are also made possible. Such movement may be made possible, for example, by means of a ball which is mounted in a sliding fashion in a socket. The curved sliding faces can also be formed by correspondingly arranged roller bearings or the like. This reduces the friction during sliding.

Furthermore it may be advantageous to provide that the sliding face is curved concavely, or that the sliding face is curved convexly.

Concave and convex sliding faces permit reliable sliding one on the other, with the movable element being centered and mounted on the fixed element. Random sliding out is prevented owing to the shape.

In still another embodiment of the invention, the fixed element has a concave sliding face on which a convex sliding face of the loose element slides, or that the fixed element has a convex sliding face on which a concave sliding face of the loose element slides.

In addition to the concave or convex curvature in a plurality of directions so that ball and socket arrangements can be produced it is also possible to provide for the curvature to be provided in one direction so that a groove-shaped arrangement is produced. This restricts the free movability of the sliding arrangement. With such an arrangement the profile of the pivot axis is easily fixed. Furthermore, simplified fabrication methods can be applied in order to manufacture the pivot bearing.

furthering yet another advantageous embodiment of the invention, the roller is pivoted by means of forces which are caused by the body during its movement.

As already described above, transverse forces and torsional forces also occur during the laying of an elongated body which rests on the corresponding roller bearings. The pivoting movements of the roller can easily be brought about by appropriately utilizing such forces. This has the advantage that a system which controls itself and which does not require any additional supply energy from the outside is provided. If appropriate forces which occur as a result of corresponding mechanisms are to be deflected in order to permit the pivotable roller to move in the desired direction.

Furthermore it may be advantageously provided that the roller is pivoted by means of an actuating element.

Using an actuating element makes it possible to initiate the pivoting of the roller in a targeted fashion. It is possible to provide here that the actuating element can be actuated independently of the progress in the transporting of the elongating body on the roller bearing. For this purpose it is possible, for example, to use electrical or hydraulic auxiliary motors which bring about the pivoting movement.

This has the advantage that the bearing can be set in a targeted fashion. The position of the support points of the body to be transported can thus be selected and set intentionally. At the same time, steady bearing of the roller bearing itself is ensured since movements which are caused by load change reactions cannot affect the actuating elements.

The invention also specifies a method for pivoting a roller of a roller bearing as described above in order to ensure that the elongated body to be moved is laid in as gentle a way as possible.

In one embodiment of the invention, there is:
at least two support points for the body are arranged on the one roller or on at least two rollers,
the roller/rollers is/are pivoted in such a way that the support forces at the support points are of approximately equal magnitude.

In particular, when the elongated body to be moved has a circular cross section, two support points are obtained, for example on two rollers which are arranged in a V shape with respect to one another, or on a roller which a concave roller body. Depending on the position of the rollers or depending on the narrowed section of the one roller and the diameter of the elongated body these support points migrate on the roller surface. When the roller or rollers is/are pivoted as a function of the support forces at the support points, symmetrical loading of the roller bearing is achieved. This symmetrical loading virtually prevents the body to be transported from tilting on the roller or rollers. As a result, the possibility of the moveable body becoming jammed on the roller bearing can be discounted.

### BRIEF DESCRIPTION OF THE DRAWINGS

The invention is shown schematically below with reference to exemplary embodiments in the drawings and will be described in more detail in the text which follows.

In the drawing:

FIG. 1 shows a first configuration of a roller bearing.

FIG. 2 shows a second configuration of a roller bearing.

FIG. 3 shows a third configuration of a roller bearing.

FIG. 4 shows a fourth configuration of a roller bearing.

FIG. 5 shows a fifth configuration of a roller bearing.

### DETAILED DESCRIPTION OF THE INVENTION

The assemblies which have the same effect in the figures are provided with the same reference symbols. The configurations of roller bearings which are illustrated in the figures are illustrated with an elongated body fitted onto them, the body having a circular cross section.

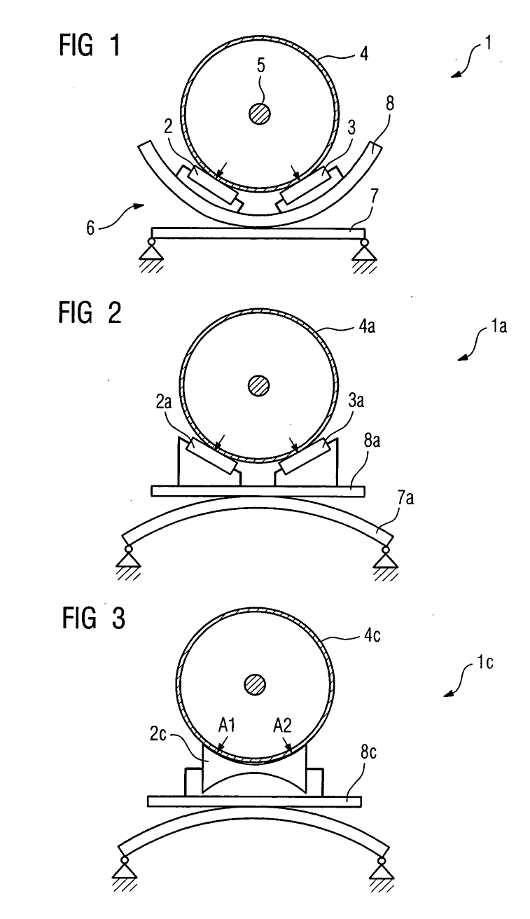

The first embodiment of a roller bearing 1 which is shown in FIG. 1 has a first rotatable roller 2 and a second rotatable roller 3. The first rotatable roller 2 and the second rotatable roller 3 are arranged in a V shape with respect to one another so that a gas-insulated electrical conductor 4 with an essentially circular cross section can be fitted on. The gas-insulated conductor 4 has a metallic, tubular outer casing. In the interior an electrical conductor 5 is held spaced apart from the outer casing of the gas-insulated electrical conductor by means of electrical insulators. In the operating state, the interior of the gas-insulated electrical conductor 4 is filled with an insulating gas. The gas-insulated electrical conductor 4 is composed of a plurality of pieces and forms an elongated body with a length between several hundred meters or thousands of meters. A gas-insulated electrical conductor 4 is composed of individual pieces and moved in the mounted state into its laying position on roller bearings. The rollers 2, 3 which are illustrated in FIG. 1 are mounted in a pivot bearing 6. The pivot bearing 6 has a fixed element 7 and a loose element 8. The first and second rotatable rollers 2, 3 are mounted on the loose element 8. The loose element 8 has a curved sliding face which can slide on a planar face of the fixed element 7. When the sliding face of the loose element 8 moves in a sliding fashion, the rollers 2, 3 which are attached to the loose element 8 are pivoted. It is possible to provide for the loose element to be a spherical cap and pivoting movements to be made possible around all axes. The degree of freedom of movement can be restricted by guide elements, for example bolts guided in connecting links so that the roller is pivoted, for example, about one axis which slides approximately parallel to the direction of movement of the body. The direction of movement of the body is arranged perpendicularly to the plane of the drawing in FIG. 1. In order to guide the loose element it is possible to provide corresponding mechanical devices. These may be, for example, bolts in connecting links, pins in channels or similar guide elements. It is possible to provide in this context that specific pivoted positions can be pre-selected and the loose element 8 can be secured to the fixed element 7 in this pivoted position.

FIG. 2 shows, in a modification of FIG. 1, a second embodiment of a roller bearing 1a with a fixed element 7a and a loose element 8a. The fixed element 7a has a curved face on which a planar face of the loose element 8a can be moved in a sliding fashion.

A modification of the roller bearing which is known from FIG. 2 is illustrated in FIG. 3. Instead of the use of two rotatable rollers, a single rotatable roller 2c is arranged on the loose element 8c. Rotatable roller 2c has a narrowed section so that a concave roller body is produced. Owing to the shaping of the roller, the elongated body 4c which is to be transported is also supported laterally. Depending on the selection of the diameter of the body 4c to be transported and the narrowed section of the roller 2c, two support points A1, A2 are also formed with such an arrangement. Depending on the dimensioning, these support points migrate along the rotatable roller.

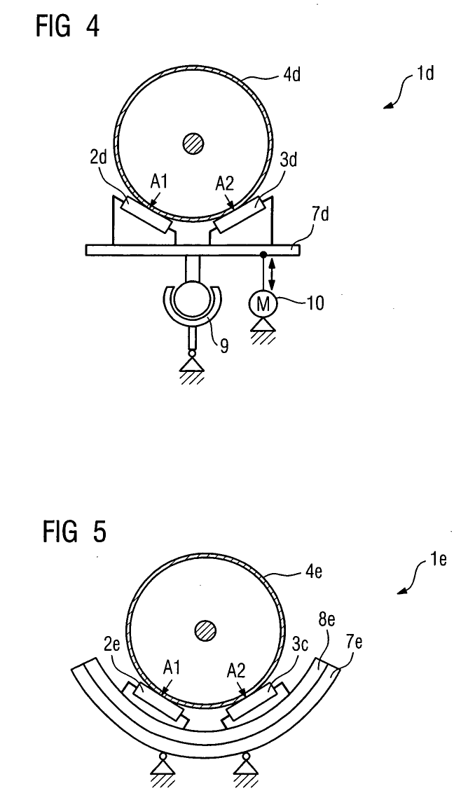

FIG. 4 shows a third configuration of a roller bearing 1d. In the roller bearing 1d, the loose element 7d of the sliding bearing is arranged on a spherical head, with the spherical head forming a curved sliding face. The spherical head rests in a socket 9. The interaction of the spherical head and the socket 9 allows the rollers 2d, 3d to pivot. Pivoting of the rollers 2d, 3d parallel to an axis of the direction of movement of the body 4d is made possible by means of an actuating element 10. In this context it is possible to provide for the support forces at the support points 1a and 2a to be measured and when there is a difference beyond a permissible amount corresponding actuation of the actuating element 10 takes place. In one configuration of a roller bearing according to FIG. 4, there is furthermore the possibility of turning the roller bearing also about the vertical axis which lies transversely with respect to the axis of movement of the elongated body and of pivoting it about further axes. For this purpose it is also possible to provide further actuating elements.

A fifth variation of a roller bearing 1e is illustrated in FIG. 5. The pivoting bearing which is formed from a fixed element 7e and a loose element 8e is configured here in the form of two concave grooves which are located one in the other. Such a configuration makes it possible to use the tilting forces or transverse forces which occur during a movement of the elongated body to generate a deflection of the rollers 2e, 3e. Owing to the groove design, the rollers 2e, 3e can be pivoted only about one axis which lies parallel to the direction of transport. When a transverse force occurs which generates an increased support force at one of the support points A1, A2, deflection is brought about in the direction of the acting transverse force owing to the sliding bearing of the loose element 8e. As a result, the rotatable roller which has been subject to less loading is subject to greater loading until there is an approximately uniformed distribution of forces at the support points A1, A2 of the rotatable rollers. When the transverse forces abate, the loose element 8e slides back into its neutral position.

Furthermore, it is also possible to provide that a plurality of roller bearings are arranged one behind the other in the axial direction of the elongated body and the respective roller bearings are actuated, for example, by a common control device and respectively assigned actuating elements permit targeted pivoting of the rotatable rollers. As a result it is possible to counteract the generation of transverse forces as soon as they appear, as well as permitting the elongated body to be laid easily.

In addition to the configuration illustrated in the figures it is possible to interchange individual elements, for example the shape of the rollers, the shape of the sliding faces, the method of movement of the sliding faces etc., with one another so that new embodiment variants are produced.

1. A roller bearing comprising at least one rotatable roller on which an elongated body configured to be moved is placed, wherein an axis of rotation of the roller is arranged transversely with respect to a direction of movement of the body, and the rotatable roller is configured to be pivoted about an axis.

2. The roller bearing as claimed in claim 1, wherein the axis is approximately parallel to the direction of movement of the body.

3. The roller bearing as claimed in claim 1, wherein the at least one roller is mounted on a pivot bearing which has a fixed element and a loose element, and at least one of the elements has a curved sliding face which is mounted in a sliding fashion on a respective other element.

4. The roller bearing as claimed in claim 3, wherein the sliding face is curved concavely.

5. The roller bearing as claimed in claim 3, wherein the sliding face is curved convexly.

6. The roller bearing as claimed in claim 3, wherein the fixed element has a concave sliding face on which a convex sliding face of the loose element slides, or the fixed element has a convex sliding face on which a concave sliding face of the loose element slides.

7. The roller bearing as claimed in claim 1, wherein the roller is pivoted by means of forces which are caused by the body during its movement.

8. The roller bearing as claimed in claim 1, wherein the roller is pivoted by means of an actuating element.

9. A method for pivoting a roller of a roller bearing as claimed in claim 1, comprising:
arranging at least two support points for a body on at least one roller; and
pivoting the at least one roller such that support forces at support points are of approximately equal magnitude.
